(19) United States
(12) Patent Application Publication
(10) Pub. No.: US 2021/0390401 A1
(43) Pub. Date: Dec. 16, 2021

(54) DEEP CAUSAL LEARNING FOR E-COMMERCE CONTENT GENERATION AND OPTIMIZATION

(71) Applicant: 3M INNOVATIVE PROPERTIES COMPANY, St. Paul, MN (US)

(72) Inventors: Brian E. Brooks, St. Paul, MN (US); Gilles J. Benoit, Minneapolis, MN (US); Peter O.N. Olson, Andover, MN (US); Thomas J. Barnidge, Apple Valley, MN (US); Audrey X. Yang, Oakdale, MN (US); Frederick J. Arsenault, Stillwater, MN (US); Tyler W. Olson, Woodbury, MN (US); Jennifer S. Hilpisch, Cottage Grove, MN (US)

(21) Appl. No.: 17/309,036

(22) PCT Filed: Aug. 26, 2019
(86) PCT No.: PCT/IB2019/057152

§ 371 Date: Apr. 16, 2021

Related U.S. Application Data
(60) Provisional application No. 62/760,342, filed on Nov. 13, 2018.

(51) Int. Cl. G06N 3/08; G06Q 10/08

(52) U.S. Cl. CPC G06N 3/08; G06Q 10/087

(57) ABSTRACT

Systems for optimizing business objectives of e-commerce content can include memory and a processor coupled to the memory. The processor can receive one or more assumptions for multivariate comparison of content. The content can be provided to users of an e-commerce system. The processor can repeatedly generate self-organizing experimental units (SOEUs) based on the one or more assumptions. The processor can inject the SOEUs into the online system to generate quantified inferences about the content. The processor can identify, responsive to injecting the SOEUs, at least one confidence interval within the quantified inferences. The processor can iteratively modify the SOEUs based on the at least one confidence interval to identify at least one causal interaction of the e-commerce content within the system. Other methods and apparatuses are described.

### FIELD OF THE INVENTION

The present invention relates to determining the effectiveness of e-commerce content and optimizing content distribution to enhance business objectives, and, more particularly, to concurrently performing these operations.

### BACKGROUND

E-commerce is a rapidly growing retail channel. Vendors can adjust how products are marketed to consumers by varying the content that will be presented to consumers as the consumers browse and transact on e-commerce sites. By varying such content, vendors can influence consumer responses and, by extension, gather insight as to how it may impact transactions of corresponding services or products. Effective management of presented content, understanding consumer responses to the content, and its continual optimization are key components for vendors to maximize their e-commerce business objectives (i.e., enhance sales and/or profit).

### SUMMARY

Herein are disclosed systems, apparatuses, software and methods for e-commerce content optimization to maximize business objectives.

In one embodiment, a system for optimizing business objectives of e-commerce content is described having memory and a processor coupled to the memory where the processor configured to: (a) receive one or more assumptions for randomized multivariate comparison of content, the content to be provided to users of the system, (b) repeatedly generate self-organizing experimental units (SOEUs) based on the one or more assumptions (c) inject the SOEUs into the system to generate quantified inferences about the content, (d) identify, responsive to injecting the SOEUs, at least one confidence interval within the quantified inferences, and (e) iteratively modify the SOEUs based on the at least one confidence interval to identify at least one causal interaction of the e-commerce content within the system.

In another embodiment, a computer-implemented method for optimizing business objectives of e-commerce content is described, comprising: receiving one or more assumptions for multivariate comparison of content, the content including content to be provided to users of a system, repeatedly generating self-organizing experimental units (SOEUs) based on the one or more assumptions, injecting the SOEUs into the system to generate quantified inferences about the content, identifying, responsive to injecting the SOEUs, at least one confidence interval within the quantified inferences, and iteratively modifying the SOEUs based on the at least one confidence interval to identify at least one causal interaction of the e-commerce content within the system.

These and other aspects will be apparent from the detailed description below. In no event, however, should this broad summary be construed to limit the claimable subject matter, whether such subject matter is presented in claims in the application as initially filed or in claims that are amended or otherwise presented in prosecution.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings, in which:

FIG. 1 is a diagram illustrating a system for e-commerce content generation and optimization according to various examples;

FIG. 2 is a block diagram of software modules and core processes for the system according to various examples; and

FIG. 3 is a flow chart of a computer-implemented method for e-commerce content generation and optimization according to various examples.

### DETAILED DESCRIPTION

For the following Glossary of defined terms, these definitions shall be applied for the entire application, unless a different definition is provided in the claims or elsewhere in the specification.

### Glossary

Certain terms are used throughout the description and the claims that, while for the most part are well known, may require some explanation. It should be understood that as used in this specification and the appended embodiments:

The singular forms “a”, “an”, and “the” include plural referents unless the content clearly dictates otherwise. As used in this specification and the appended embodiments, the term “or” is generally employed in its sense including “and/or” unless the content clearly dictates otherwise.

The terms independent variable (IV) and external variable (EV) are generally employed as the variable manipulated by the user and the variable uncontrolled by the user. Independent variables may be discrete or continuous. External variables are typically continuous.

The term “level” as used with experimental units is generally employed as a status of a feature or option of the independent variable (IV). For example, if two levels of a feature are defined, then a first level implies that the feature is active in the experimental unit and a second level would be defined as it not being active. Additional states or statuses may be defined then just active or not active for an IV.

The term “repeatedly” is generally employed as occurring constantly with or without a specific sequence. As an example, a process may constantly or iteratively follow a set of steps in a specified order (e.g., if a process contains steps 1-5, then the process implement steps 1, 2, 3, 4, 5 in that order or in reverse order—steps 5, 4, 3, 2, 1) or the steps may be followed randomly or non-sequentially (e.g., 1, 3, 5, 4, 2 or any combination thereof).

“Exchangeable” or “exchangeability” is generally deployed as meaning statistically equivalent with respect to the outcome of content assignments.

The terms “causation” or “causal relationship/interaction/inference” are a positive or negative indication that the presence, absence, variation, or modification of specific content has an impact or influence on other content and its ability to influence user interaction (i.e., purchase a specific product).

“Positivity” is generally defined as meaning not less than zero or a non-zero probability of occurrence or selection.

The term “confound factor” includes Hawthorne effects, order effects/carry over effects, demand characteristics, external variables, and/or any other factor that could vary systematically with the levels of the independent variable.

The recitation of numerical ranges by endpoints includes all numbers subsumed within that range (e.g. 1 to 5 includes 1, 1.5, 2, 2.75, 3, 3.8, 4, and 5).

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

Various exemplary embodiments of the disclosure will now be described with particular reference to the Drawings. Exemplary embodiments of the present disclosure may take on various modifications and alterations without departing from the spirit and scope of the disclosure. Accordingly, it is to be understood that the embodiments of the present disclosure are not to be limited to the following described exemplary embodiments, but are to be controlled by the limitations set forth in the claims and any equivalents thereof.

In general, humans and many machine learning implementations make decisions under conditions of probabilistic uncertainty. Recognition of patterns, inferences, or connections within a data set by passive observation is challenging without introducing conscious or unconscious bias or undisciplined assumptions. The data set may provide additional challenges as it may introduce 1) selection or sampling bias, 2) confounding variables, and 3) lacks evidence of directionality. Controlled or adaptive experimentation aims to eliminate bias by introducing randomization, blocking, and balancing aspects yet remains impeded from the vast amount of a priori knowledge required to provide tangible outcomes (i.e., ensure high internal and external validity) and the inflexible constraints imposed by real-world decisions. Adaptive experimentation performs one or more steps in a sequential manner and oftentimes requires previous steps be concluded before a subsequent step may be addressed. The techniques described herein overcome passive observation and adaptive experimentation by transforming controlled or adaptive experimentation into non-sequential processes that repeatedly analyze and optimize data through self-organized experimentation. The self-organized processes rationally exploit natural variability in the timing, order, and parameters of decisions to automatically calculate and definitively infer causal relationships. An advantage of the self-organized adaptive learning system and method over existing adaptive experimental techniques includes the ability to operate on impoverished input where conditions or interactions are initially unknown, incomplete, or hypothetical estimates and are learned over time. Another advantage of the adaptive learning system and method is its robustness to false assumptions including the impact of time, duration that content conditions should or could be analyzed, and external factors (e.g., consumer fads or trends, seasonal variation, natural or manmade disasters, etc.). Iterative exploitation of casual relationships that are spatiotemporally discontinuous is another advantage over existing systems as the location of content and its comparative impact against an array of other content are of critical importance in understanding and optimizing content that is the most effectual for e-commerce systems.

The system and method deliver real-time understanding and quantification of causation while providing fully automated operational control and integrated multi-objective optimization. The behavior of the self-organizing system and method is robust, scalable, and operational effective on complex real-world systems including those that are subject to deviations in spatial-temporal relationships and product diversity (i.e., e-commerce systems).

In modern e-commerce systems, vendors can influence different types of consumer behavior based on displayed and interactable content elements. A challenge experienced in e-commerce systems involves indicating measurable consumer responses to the content. Some vendors focus on consumer responses that are easy to measure and understand and can include click rates or responses to surveys/questionnaires. For example, consumer “clicks” are one type of consumer response that analyze what products, images, or links that a consumer browses or interacts with on the e-commerce site. They are a measure of interest that may or may not result in the actual conclusion of a product sale. Typically, comprehensible and easy to measure consumer responses may not accurately reflect parameters that provide strategic direction to vendors, such as sales, revenue, and profits. As an example, a consumer may have clicked a link because an image caught their attention and they had no intention of buying the corresponding product. In this example, a vendor seeking only to optimize the number of “clicks” on an e-commerce site selling their products may therefore miss out on the opportunity to choose content that directly enhances sales and profits. “Clicks” are variable and consumer behavior differs on what they may represent and how they are interpreted as conversions (i.e., indication that specific content influenced the sale). For example, one consumer may already know that they want to buy a product from an e-commerce site and will click on it once and then procure. Another consumer may actively browse the multiple e-commerce sites one or more times on the same day or throughout a duration of days or weeks before actually buying the product. Systems that intend to maximize correlation must understand what content directly leads to a sale and when it was confirmed.

In many e-commerce systems, displayed or interactable content options are manually selected to address business objectives (i.e., increase sales and profits), which is expensive and time/labor intensive. Such manual selection becomes increasingly difficult for e-commerce sites managing multiple products. Furthermore, optimizing sales of individual products may win market share from competitors, but could result in cannibalization of a vendor's similar products. For example, a vendor may sell multiple furnace filters, having many different options and profit margins. The vendor would prefer that the furnace filters be purchased over competitor brands, but at the same time the vendor would prefer that furnace filters having a greater profit margin are purchased instead of furnace filters having a lesser profit margin. By merely optimizing sales, the vendor may miss the opportunity to optimize profits or revenue. Generally, each product is managed individually and its interaction with others is not considered. Another advantage of the self-organized adaptive learning system and method is its ability to assess and address product cannibalization and, more generally, product portfolio optimization.

Embodiments include methods and systems for optimizing business objectives on e-commerce platforms. System inputs can include candidate content elements (e.g., snippets of text and/or images) and constraints (e.g., 200-character limit of product title or description) for how and why content can be combined for presentation to consumers. Inputs can also include initial assumptions regarding, for example, business objectives, historical context and previous discoveries/learnings, time differentials between viewing content and making a purchasing decision, and systematic constraints. Systems according to embodiments can specify a protocol for assembling content elements. Methods according to some embodiments can identify causal relationships between the served content elements and purchase behavior while optimizing revenue and profit. The system can be configured to any objective goal as represented by human behavior. As described in greater detail below, causation is measured by computing statistical significance of the presence (relative to the absence) of a content element on or within a group of self-organized experimental units. Assessment of the statistical significance is accomplished by computing a confidence interval, which quantifies the expected value of the content element's effect and the uncertainty surrounding it (and represents a measure or degree of inference). The computation of unbiased confidence intervals in this case is relatively straightforward because of random sampling/randomization. Interpretation and adaptive use of the confidence intervals to automatically understand and exploit the specific effects of content inclusion, placement, and duration and their self-organizing comparisons to other content (to eliminate confounding effects of covariates) analogous to deep learning is what advantageously differentiates this system and method from the limitations of current solutions. Computation of one or more confidence intervals allow for risk-adjusted optimization since they quantify both the expected effect as well as the range around it (i.e., quantification of the best and worst-case scenarios). Methods and systems according to embodiments can identify and adjust for false inputs (e.g., false assumptions) that would confound cause-and-effect knowledge and limit optimization results, as well as monitor and exploit changes in causal relationships between content and consumer behavior.

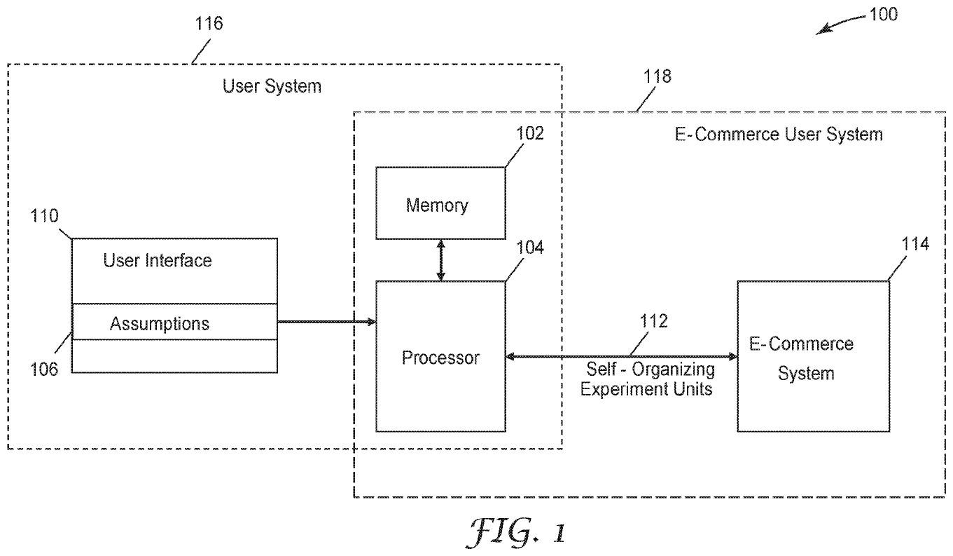

FIG. 1 is a diagram illustrating a system 100 for e-commerce content generation and optimization according to various examples. The system 100 includes a memory 102 and a processor 104 coupled to the memory 102. The processor 104 can receive inputs from a user interface 110 including one or more assumptions 106 for multivariate comparison of content. Assumptions 106 may also be retrieved from memory 102. Inputs can further include content elements, which can also be stored in or accessed from memory 102. The content, as described earlier herein, is to be provided to and optimized on an e-commerce system 114 to maximize a business objective.

Processor 104 and memory 102 may be part of a user system 116 that includes the user interface 110 from which to input assumptions 106. As an example, user system 116 may be a mobile device (e.g., smartphone, laptop, etc.) or stationary device (i.e., desktop computer) running an application on the device or in a Cloud environment that displays the user interface 110 and connects to the e-commerce system 114 through a wired or wireless network. In another embodiment, the processor 104 and memory 102 may operate on an e-commerce user system 118. The e-commerce user system 118 would receive input from a user interface 110 that is operating on a mobile or stationary device running an application on the device or in Cloud environment. Assumptions 106 including content elements would be directly stored and processed in the e-commerce user system 118. The user system 116 and e-commerce user system 118 may also operate concurrently implying that data is stored and processed interchangeably between them.

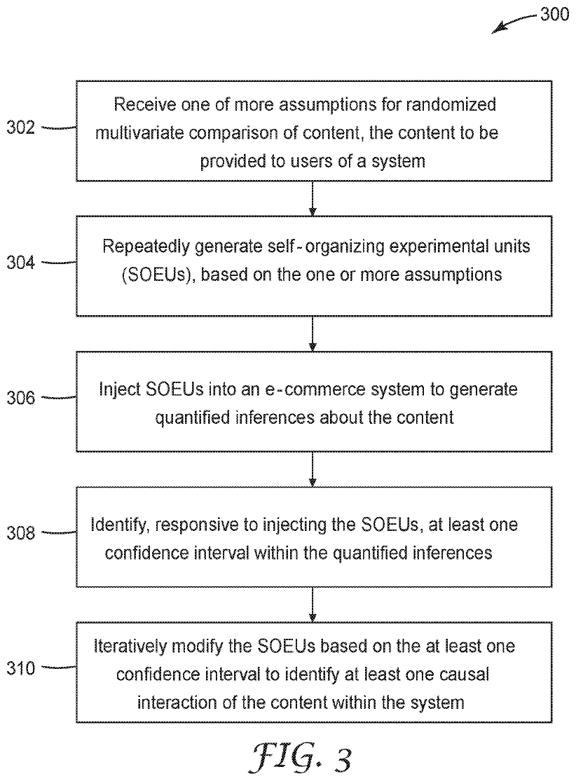

The processor 104 can repeatedly generate self-organizing experimental units (SOEUs) 112 based on the one or more assumptions 106. The SOEUs 112 (which will be described in more detail later herein with respect to FIG. 3 and associated tables) quantify inferences within and among the content.

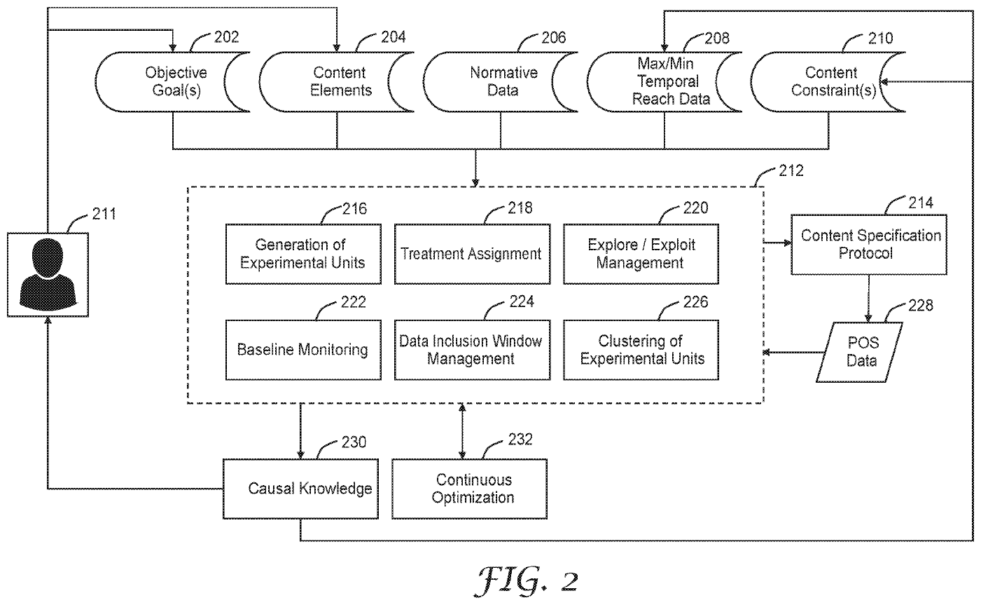

At least one SOEU 112 can include a duration for which the respective SOEU 112 is to be active in the system (e.g., the e-commerce system 114). The processor 104 can generate a plurality of SOEUs 112 with durations randomly selected based on a uniform, Poisson, Gaussian, Binomial, or any distribution supported on a bounded or unbounded interval. In one embodiment, the duration may be the longest duration of all generated SOEUs and all intermediate durations would be simultaneously recorded. The processor 104 could then select the duration of all recorded durations that maximizes statistical significance. The processor 104 can also dynamically modify (i.e., increase or decrease) the latent duration between SOEUs 112 until carryover effects of an SOEU 112 on a subsequent SOEU 112 are diluted or wholly eliminated implying that effects are fully reversible. The processor 104 may increase or decrease durations of at least one SOEU 112 based on quantified inferences or in adaption to positive or negative results of the causal assessment (i.e. assessment of external validity by comparing exploit vs baseline where baseline may be the average of all possible content options as defined in greater detail with respect to FIG. 2).

The e-commerce system 114 can include online shopping or product sales portals, websites, or mobile applications. E-commerce system 114 can be for example enterprise content management systems that optimize business-to-business (B2B) objectives or direct to consumer private or public portals that display and transact products (e.g., Amazon, Target, Home Depot, Walmart, etc.). Intranet or internet search engines (e.g., Google, Yahoo, Bing, etc.) are also included as consumers/users leverage them to explore products, compare prices, and read customer reviews. Each SOEU 112 can represent one product or can represent a variation of content specific to one product. The processor 104 can group the SOEUs 112 into blocks or clusters based on quantified inferences of variance in content effects across experimental groups. Quantified inferences are based on the characteristics of the content contained in individual SOEUs as well as across the experimental group such as product, time of year, geographic location, etc. The processor 104 can identify distinct causal interactions for each cluster and select optimal content for each cluster based on the separate causal inferences for each cluster.

Once generated, the processor 104 can continually inject the SOEUs 112 into the e-commerce system 114, iteratively modify the SOEUs 112 according to methods and criteria described below with respect to FIG. 3, and identify at least one causal interaction of the content within the e-commerce system 114. The processor 104 can assign content to SOEUs 112 initially uniformly and iteratively less uniformly proportional to the amount of evidence of relative expected utility as quantified by the confidence intervals. The processor 104 can generate at least one group of SOEUs 112 based on a uniform probability distribution of the encompassing experimental units related to at least one assumption 106 with defined treatments as described below.

Assumptions 106 can include objectives for the e-commerce system 114. The objectives can include performance metrics that the system risk-adjust optimizes. Examples include, but are not limited to: revenue, top or bottom-line sales, gross profit, profit margin, cost of goods sold (COGS), inventory management/levels, price, transportation/shipping costs, market share, or combinations thereof.

Assumptions 106 can include content elements that identify product attributes or specific details. Examples include, but are not limited to: product title, description, purpose, dimensions, price, or combinations thereof.

Assumptions 106 can include temporal constraints or a specific constraint on content. A temporal constraint involves time and the duration for which the content would be active, inactive (i.e., only appropriate at specific times of a day or a year), or displayed in the system. Constraints on content include the presence or absence of a product image or video, standardization in product brand name or designation, empty or blank text, duplicated text, use of symbols, maximum amount of characters that may be used, or combinations thereof.

Assumptions 106 can be initially defined and then recurrently updated, manually or automatically, as additional information becomes available or as the system analyzes and optimizes causal inferences.

User interface 110 is a web or application based portal that the user accesses to enter assumptions 106 for the system. User interface 110 may be presented as a graphical user window on a monitor or smart phone display. A user would enter assumptions 106 through a keyboard or virtual keyboard on the device used to access the system.

Components of the system 100 may operate on a stationary (e.g., desktop computer or server) and/or mobile device (i.e., smart phone) while connected to the e-commerce system through local, group, or Cloud based network. The one or more components of the system 100 may also operate on the stationary and/or mobile device after a connection and directions have been received by the e-commerce system 114.

FIG. 2 is a block diagram of software modules and self-organizing core processes for the e-commerce content generation and optimization system 100 for execution by processor 104.

The software modules and self-organizing processes include: an objective goal(s) module 202; a content elements module 204; a normative data module 206; a max/min temporal reach data module 208; and a content constraints module 210. The objective goal(s) module 202, the content elements module 204, the normative data module 206, the max/min temporal reach data module 208, and the content constraints module 210 can provide enough structure to start generating SOEUs 112 (FIG. 1) without also requiring exhaustive, concrete detail and precision.

Human supervisors or artificial intelligence (AI) agents 211 can adjust content elements and content constraints at any time before, during, and after the method implementation or when it is rational to do so. For example, when the system and method are operating at a maximum value of a boundary condition (as defined by a constraint) and the impact of the effect has not yet plateaued. In some embodiments, the processor 104 may provide (e.g., to a display) indications of potential actions to be taken by a human supervisor or AI agent. Feedback or updates to assumptions or objectives may also be accepted from the human processor or AI manually or automatically (i.e., customer reviews or trends received by social media sites).

The processor 104 may additionally prompt or enable users to provide an on-going prioritized list or queue of candidate content options. If this queue is provided to the processor 104, the processor 104 can rationally introduce the new options when doing so will not negatively impact optimality. Similarly, content options can be removed when the processor 104 detects that those content options have little or no benefit, prompting human operators to review those content options for removal.

The processor 104 can also adjust for the fact that the cost to change content may not be zero. The costs of content change can become part of the objective goals and utility measured by the processor 104 confirming the resource allocation optimization problem where cost (usually known) is balanced with perceived potential value (not yet quantified).

The objective goal(s) module 202 receives, stores, displays, and modifies e-commerce one or more conversion performance metrics that the system will optimize. These goals can range from simple metrics (e.g. sales, revenue, gross profit, COGS, etc.) to weighted combinations or any other functional transformation of multiple metrics (e.g. factoring complex cost factors, supply chain concerns, stock availability, etc.). The metrics and their correspondingly user assigned weights (i.e., importance values), if designated, are combined into a multi-objective utility function. User assigned weights may be expressed as a number or a percentage. In some embodiments, weight values are non-negative and non-zero and may be less than, equal to, or greater than 1, 5, 10, 15, 20, 25, 30, 35, 40, 45, 50, 55, 60, 65, 70, 75, 80, 85, 90, 95, or 99%. In other embodiments, weight values may be numeric and may be less than, equal to, or greater than 1, 5, 10, 15, 20, 25, 30, 35, 40, 45, 50, 55, 60, 65, 70, 75, 80, 85, 90, 95, or 99. The multi-objective utility function may be modified or refined at any point in time when (or where) business objectives change (i.e., aggressive market penetration to maximize revenue).

Content elements module 204 receives, stores, displays, and modifies user-provided content options including a full array of combinatoric search space of possible content. Content elements are specific instances of text, images, videos, etc. that define a service or product in technical or marketing language. Further examples of content elements include: customer reviews of procured products on the e-commerce systems or other web pages or sites, payments of products or services, use of financial incentives (i.e., discounts), and inventory levels/management. Note that the content elements can be granular to control (for example) phrases/words, image elements, etc. Content elements may be manually entered or updated through a user interface (i.e., user interface 110 of FIG. 1) or be automatically pasted, imported, copied, or uploaded into the system from another program application or platform (e.g., MICROSOFT, LinkedIn, Pinterest, Facebook, Amazon.com, other social media sites, etc.) using natural language processing, sentiment analysis, generative adversarial networks, etc. Importantly, content elements can be updated (e.g., added and/or deleted) without affecting what the system has already learned.

Normative data module 206 receives, stores, modifies, and represents past or historical conversion performance metrics (corresponding to the defined objective goal(s)) describing e-commerce product performance prior to the implementation of the system for a group of services or products. This data may be optionally used to calibrate the system and its initial decision variation. It also includes previous discoveries or inferences that the user or system learned during prior implementation. Normative data may be manually entered through a user interface (i.e., user interface 110 of FIG. 1) or be automatically imported, copied, or uploaded into the system from another program or platform (e.g., ORACLE, MICROSOFT, TURBOTAX, SAP, etc.).

Max/min temporal reach data module 208 receives, stores, modifies, and represents the initial estimates of the maximum and minimum extent to which the causal effects of content variation in actions/decisions spread and decay throughout the e-commerce system. Decay in this instance refers to the amount of time that an experimental unit is deactivated before another one is activated. It refers to the amount of time for the outcome of specific content assignment to clear the system, (i.e., be undetectable). A system-defined or user defined duration (be it time or a percentage of time) may also exist between when an experiment is active and inactive. This module is used to define the initial search space and for generating orthogonal self-organized experimental units.

Content constraints module 210 involves the set of user or e-commerce system provided content rules that restrict the overall combinatoric search space of possibilities. The content constraints module 210 receives, stores, modifies, and represents user or system defined constraints. They include user defined or e-commerce system specified rules and deterministic models that define the boundaries (or limitations) of the content. Constraints may be “soft” implying that the system will adhere until evidence is provided that the assumption defining it is false or “hard” implying that the system will adhere (i.e., never violate) without deviation or consideration of other evidence. Constraints include but are not limited to: the location where in the e-commerce platform content can be applied (e.g. product title vs. detailed product description); constraints on multiplicity and co-occurrence (e.g. if content can be repeated, content options that cannot be used together); and constraints dictated by e-commerce platforms (e.g. maximum character length of product titles). Constraints can be updated during implementation as inferences are quantified to explore the impact on utility at or near the boundaries. Content elements and constraints are an opportunity for human agents to manage risk vs. reward by constraining or broadening the range of options for the system.

The objective goal(s) module 202, the content elements module 204, the normative data module 206, the max/min temporal reach data module 208, and the content constraints module 210 are used by the core algorithmic methods and processes 212 to generate a content specification protocol 214 that defines the real-world content to apply at any given point in time. The core algorithmic methods and processes 212 may be initialized by a human, another machine learning method (e.g. for initializing correlation inferences), other statistical methods (e.g. for defining initial sampling probability distribution of experimental units and content elements), or combination thereof. The core algorithmic methods and processes 212 include the following: a generation of experimental units process 216; a treatment assignment process 218; an explore/exploit management process 220; a baseline monitoring process 222; a data inclusion window management process 224; and a clustering of experimental units process 226.

Generation of experimental units process 216 identifies statistically equivalent spatial-temporal units (i.e., where the experimental conditions are equivalent and where the units' duration is pareto optimized to minimize carry-over effects while maximizing statistical power) based upon input received from the core modules 202, 204, 206, 208, and 210. An ideal experimental unit is characterized by the smallest spatial/temporal extent that prevents carryover effects from degrading the causal knowledge generated. In one embodiment it can be identified by systematic exploration of the spatial/temporal extent of the experimental units to discover the optimum unit size corresponding to the mean effect sizes that lies at the 95% confidence interval (p=0.05) from the asymptotic mean effect for large spatial-temporal extents. Generation of experimental units process 216 identifies exchangeable experimental units (i.e., forms clusters of exchangeable experimental units) and optimizes their spatial and temporal properties within each cluster by minimizing carry-over effects while maximizing statistical power (i.e. number of EUs). Examples of the generation and execution of experimental units, selection and use of independent and dependent variables, and assignment of spatial/temporal conditions are described, for example, in commonly owned U.S. Pat. No. 9,947,018 (Brooks et al.) and US Patent Publication No. 2016/0350796 (Arsenault et al.).

Treatment assignment process 218 provides controlled random assignment of content elements to experimental units (such as randomization without replacement, counterbalancing, and blocking) with assignment frequencies following a uniform or pre-defined probability distribution (i.e., historical or normal operation) until variance in utility is detected, explored, and exploited. Within each cluster of exchangeable experimental units, independent variable (IV) level assignment may follow a full factorial design, a fractional factorial design, a block design or a Latin square design, which allows for multiple blocking factors. Independent variables (IVs) are assigned such that the relative frequency of assignment matches the relative frequency specified by the explore/exploit management process (described below). Blocking involves balancing assignment across external factors (i.e., confounds) while clustering involves isolating assignments per confounding factors. Whether blocking or clustering is chosen depends upon the strength of the covariates as well as statistical power (i.e., only begin clustering once sufficient SOEUs have accumulated). They can coexist when the number of external factors is large and both are integral parts of the “self-organization” process.

Carryover effects of content assignment within experimental units are operationally and adaptively controlled. Carryover effects imply that the effect of one content assignment contaminates the measured effect of the next treatment. To eliminate carryover effects, the duration of treatment assignments must match the max/min temporal reach of the effects. For examples, if min=0 and max=4, then the optimum may be duration of 4 with a frequency of ⅛ (use the last 4 days during an 8-day period). In another example, if min=4 and max=4, then then optimum may be duration of 1 with a frequency of 1. It may also be dependent on whether the effect is persistent (i.e. stable over time within the duration of the experiment) or transient (i.e. changes over time within the duration of the experiment).

Explore/exploit management process 220 analyzes confidence interval (CI) overlaps by probability matching, rational choice theory, or other techniques to explore frequencies where smaller overlaps between CIs result in more frequent use of the level associated with the highest utility. For each experimental unit, the system needs to decide whether to allocate the experiment toward making the most probabilistically optimal decision or toward improving the precision of the probability estimate (i.e., CI). The system can vary the aggressiveness of the exploit assignments and place itself under experimental control to find the aggressiveness that maximizes utility (including minimizing regret) relative to the explore assignments as determined through baseline monitoring where baseline is defined as the average of all levels (i.e., explore). The system monitors the gap between exploit and explore providing an objective measure of regret. Regret is the expected decrease in utility/reward due to initiating the explore process instead of optimizing with the exploit process. When the cost (including opportunity cost) for executing treatments is non-uniform across independent variable levels, Bonferroni-corrected confidence intervals (or inferences) are computed such that more evidence is required to exploit more expensive treatments.

Baseline monitoring process 222 continuously analyzes the baseline in real-time through periodic random assignment to provide an unbiased measure of utility improvement. Baseline may be assigned depending on what metric is desired to quantify value; its default state may be assigned to explore or exploit. In addition to experimental units being allocated as described above, the system continuously determines through statistical power analysis the number of baseline experimental units needed to monitor the difference in performance between these baseline trials and the treatment assignments. Baseline experimental units are randomly sampled according to the normative operational range data. The difference between the baseline trials and the explore/exploit trials provides an unbiased measure of utility of internal parameters (including clustering, the data inclusion window, explore/exploit aggressiveness), allowing such parameters to be objectively tuned. The baseline trials also ensure that the entirety of the search space defined by the constraints is explored.

Data inclusion window (DIW) management process 224 uses factorial ANOVA or other methods (i.e., normality testing) on experimental unit duration to analyze the impact of time variance on the stability of the strength and direction of interactions between the selected independent variables and the utility function and thus the extent to which data are representative of the current state of the e-commerce system for real-time decision support. For each independent variable, it identifies a pareto optimum data inclusion window that maximizes both experimental power (across all experimental unit clusters and the entire decision search space) and statistical significance of causal effects. This prevents the process from over-fitting the data and allows it to remain highly responsive to dynamic changes in the structure of the underlying system. Confidence intervals are computed over a pareto optimum data inclusion window to provide a trade-off between precision (narrow confidence intervals) and accuracy as conditions change over time. The DIW may be user defined initially based upon the inputted constraints. In general, the system operates on the presumption of instability (i.e., it is not 100% stable) and dynamically adapts.

Clustering of experimental units process 226 conditionally optimizes SOEU injection and content assignment based on external factors outside of experimental control to provide honest or unbiased evidence for causal interactions. Clustering is used to manage dimensionality in the system by learning how to conditionally assign independent variable levels based on the factorial interactions between their effects and the attributes of the experimental units that cannot be manipulated by the system (e.g., seasonal or weather effects, content demand, placement on the e-commerce site, etc.). The dimensionality/granularity of the system (i.e. number of clusters) is always commensurate with the amount of data available. Therefore, there is no limit on how many external factors could or should be considered. External factors with large effects are identified and firstly clustered, while others are managed through blocking. The more that is known about the characteristics of the experimental units, the more effective the processes are at eliminating confounds and effect modifiers. Confounds are generally addressed by randomization and effect modifiers are eliminated through clustering. Initial assumptions include what characteristics should be considered based on a-priori knowledge or evidence that they in fact matter. Assumptions can be added or deleted over time as needed. Adding more characteristics does not necessarily increase dimensionality as they will be ignored until evidence supports the need for clustering. It is achieved by pooling experimental units into clusters with maximum within-cluster similarity of the impact of independent variables on utility and maximum between-cluster difference. The number of clusters is optimized using two related mechanisms: 1) techniques including factorial ANOVA, independence testing, conditional inference trees, etc. may be used to find the factors that explain the largest amount of variance between clusters and stepwise statistical power analysis is used to select a number of factors that results in clusters with sufficient statistical power to find exploitable effects and 2) clustering decisions are placed under experimental control by continuously testing them and using baseline monitoring to objectively explore and exploit their impact on utility.

Table 1 illustrates how each of the core algorithmic methods and processes 212 (FIG. 2) can operate by phase once the e-commerce system is implemented. Phases are defined as initiation, explore/exploit, cluster initiation, and continuous cluster optimization. The initiation phase occurs as soon as assumptions 106 (FIG. 1) have been inputted and defined. The system begins to analyze data contained in the objective goals, content elements, normative data, max/min temporal reach data, and content constraints modules (FIG. 2—202, 204, 206, 208, and 210) to define variables and experimental unit breadth. The explore/exploit phase repeatedly assesses the data using statistical probability matching, adjusts experimental unit duration to investigate search space definition, and determines cluster assignment. The cluster initiation phase actively analyzes one or more assigned clusters and their potential impact to repeatedly computed confidence intervals. The continuous cluster optimization phase calculates cluster variability to identify causal inferences among confidence intervals.

TABLE 1
Core Algorithmic Methods and Processes Implementation by Phase

| | Experimental | | Data Inclusion | Clustering of | Explore/ |
|---|---|---|---|---|---|
| | Unit | Treatment | Window | Experimental | Exploit |
| | Generation | Assignment | Management | Units | Management |
| Phase | FIG. 2-216 | FIG. 2 [symbol] 218 | FIG. 2 [symbol] 224 | FIG. 2-226 | FIG. 2-220 |
| Initiation | Vary EU size | Assign | DIW extends | Define one | Pure |
| | | treatment | to start | cluster | exploration |
| | | matching | | | |
| | | normative | | | |
| | | operational | | | |
| | | frequencies | | | |
| Explore/ | Continue to | Assign using | Vary DIW to | Maintain one | Optimize ratio |
| Exploit | vary and adjust | probability | maximize delta | cluster | of pure explore |
| | EU size | matching | between | | versus explore |
| | | | baseline and | | trials to find |
| | | | explore/ | | reliable delta |
| | | | exploit trials | | between |
| | | | | | classes |
| Cluster | Continue to | Assign using | For each | Define three | For each |
| Initiation | vary and adjust | probability | cluster, vary | clusters (one | cluster, |
| | EU size | per matching | DIW to | pure | optimize ratio |
| | cluster | exponent, | maximize delta | benchmark and | of pure explore |
| | | adjust | between | the others by | versus explore |
| | | exponent | baseline and | IV) | trials to find |
| | | based on delta | explore/ | | reliable delta |
| | | between pure | exploit | | between |
| | | explore vs. | | | classes |
| | | explore/exploit | | | |
| | | hybrid | | | |
| Continuous | | | | Vary clusters | |
| Cluster | | | | using | |
| Optimization | | | | “ANOVA” as | |
| | | | | hypothesis | |
| | | | | generation | |

Point of sale business data module (POS Data) 228 receives, stores, and accesses data related to customer transactions including payments of products or services, use of financial incentives (i.e., discounts), inventory levels, and supply chain management. The information uploaded and used in the point of sale (POS) business data module 228 may provide additional context to generate and iterate SOEUs and to identify causal inferences. POS data may be received daily, weekly, monthly, yearly, etc. and its reception is based largely on the structure and requirements of the e-commerce site.

Causal knowledge module 230 systematically executes the core algorithmic methods and processes 212 (previously defined) to compute confidence around the relative effects of different content assignments, representing the expected value of the effect on the multi-objective optimization function and the uncertainty around this estimate, while minimizing confounds from external or internal factors, exploring/exploiting causal inferences, and optimizing operations based on initially defined or refined objectives. Confidence intervals are computed in the causal knowledge module 230 for each independent or dependent variable level or combinations of independent variable levels. They are calculated by taking the difference between the mean effect when a variable is activated and when it is deactivated over the data inclusion window providing estimates of the causal effect. Exemplarily, in some embodiments, confidence intervals per duration may be calculated simultaneously or sequentially if data inclusion windows satisfy normality testing (i.e., Shapiro-Wilk test) with max p-value (i.e., 0.05) for each duration. Or the duration with the maximum statistical power (or alternatively the minimum t-test p-value) over each respective data inclusion window may be selected. There may be a specific data inclusion window per variable and per cluster (i.e., they may all be identical or distinct). Execution of the processes needs not be sequential and as they are advantageously operated independently as frequently as needed to improve optimization capability. Incremental value of learning versus exploiting (i.e., how much more value is there to capture probabilistically?) is continually assessed, including the potential impact of adding, editing, or removing independent variables (i.e., expanding the search space). Causal inference requires: 1) exchangeability among the experimental units implying that they are exchangeable at any time during analysis and the outcome would not be altered, 2) independence (i.e., no carry over effects) among experimental units, 3) consistency of treatment assignment and management, 4) reversibility of the effects, and 5) positivity in selection.

Continuous optimization module 232 evokes processes to identify, monitor, and improve upon the clustering of experimental units process 226 and explore/exploit management process 220 by further refining the effectiveness of probability matching.

FIG. 3 is a flow chart of a computer-implemented method 300 for content generation and optimization according to various examples. Operations of the method 300 can be performed by elements of the system 100, or by elements of FIG. 2, and reference is made to elements within the system 100 or FIG. 2. The steps outlined in FIG. 3 and the computer-implemented method 300 may be performed concurrently, in different order, or may include steps that are not specifically identified.

Method 300 is explained using an illustrative example. In the illustrative example, a vendor desires to optimize sales respecting two products provided on an e-commerce site. The two products were designated PR01 and PR02.

Referring to FIG. 3, and illustrated using the example scenario outlined above, method 300 for content generation and optimization begins with operation 302, with the processor 104 (FIG. 1) receiving one or more assumptions for randomized multivariate comparison of content. The content was provided by the vendor to the e-commerce system 114 (FIG. 1). The assumptions include descriptive content and constraints on the content, for example, as provided by the content elements 204 and content constraints module 210. The constraints include a temporal constraint (e.g., provided by max/min temporal reach data module 208) or a constraint on content type, or other constraints or combinations thereof. The assumptions include objectives for the e-commerce system 114, for example as received by the objective goal(s) module 202.

In this example, objective goals (managed by the objective goal(s) module 202 (FIG. 2)) include optimization of the sales of two products and were entered into the user system 116 through the user interface 110 (FIG. 1). Content elements (managed by the content elements module 204 (FIG. 2)) include, for example, product titles and identified descriptive features. Normative data (managed by the historical conversion data module 206 (FIG. 2)) included historical sales data reported and collected for the two products. Max/min temporal reach data (managed by the minimum/maximum temporal reach data module 208 (FIG. 2)) included data as to how soon consumers purchased a product after being exposed to product content. For example, with respect to PR01, 95% of consumers may purchase the product within 1-3 days of exposure its content on the e-commerce site. A summary of the assumptions is represented in Table 2. One constraint was defined and limited the number of alphanumeric characters that could be used for the descriptive features.

TABLE 2
Reception of Assumptions

| Name | Title | Feature A | Feature B | Feature C | Price | Max/Min Temporal Reach |
|---|---|---|---|---|---|---|
| PR01 | Title | Feature A | Feature B | Feature C | Price | Time |
| PR02 | Title | Feature A | Feature B | Feature C | Price | Time |

Content options were then provided by the vendor that best communicate or express information about product title or descriptive features that could elevate interest and lead to a sale. Example content options for the two products are represented in Table 3. <Blank> denotes that no text was provided as an option or that the content option was not defined. The variables (Title 1, Title 2, A1, A2, B1, B2, and C1) represent any alphanumeric text designating that feature (such as “durable”, “superior performance” or “available in multiple colors”, etc.). Some of the feature options were similar and others were different among the two products. For example, Feature C options are the same for both products and Feature A and B options are different.

TABLE 3
Product Content Options

| Name | Title Options | Feature A Options | Feature B Options | Feature C Options |
|---|---|---|---|---|
| PR01 | Title 1 or Title 2 | <Blank> or A1 or A2 | <Blank> or B1 | <Blank> or C1 |
| PR02 | Title 1 or Title 2 | <Blank> or A2 | <Blank> or B1 or B2 | <Blank> or C1 |

Method 300 continues with operation 304 with the processor 104 repeatedly generating SOEUs 112, based on the one or more assumptions, that quantify inferences among the content. In the illustrative example, an SOEU 112 consists of repeatedly generating and iterating the core algorithmic methods and processes 212 (FIG. 2).

The generation of experimental units process 216 (FIG. 2) assigned variables and randomized content options to begin the analysis of their effect in the e-commerce system. Table 4 represents variable assignment based on the captured assumptions and content options for this example. EV represents external variables. IV represents an independent variable. RV represents the response variable to the content assignment (e.g., level dependent within the independent variables.

TABLE 4
Experimental Unit Variable Assignment

| Variable | Definition |
|---|---|
| EV1 Sales 1 | Historical Sales Velocity for PR01 |
| EV1 Sales 2 | Historical Sales Velocity for PR02 |
| IV1 Level 1 | Title 1 |
| IV1 Level 2 | Title 2 |
| IV2 Level 1 | <Blank> |
| IV2 Level 2 | A1 |
| IV2 Level 3 | A2 |
| IV3 Level 1 | <Blank> |
| IV3 Level 2 | B1 |
| IV3 Level 3 | B2 |
| IV4 Level 1 | <Blank> |
| IV4 Level 2 | C1 |
| RV1 | Resulting Effect for IV1 |
| RV2 | Resulting Effect for IV2 |
| RV3 | Resulting Effect for IV3 |
| RV4 | Resulting Effect for IV4 |

In some embodiments, the processor 104 can generate experiments with durations randomly selected based on a specific statistical distribution. Several factors influence or lead to the selection of the statistical distribution and generally involve a trade-off between efficiency and computational duration. The statistical distribution can be uniform if no prior knowledge indicates that one duration is better than another, it can be normally distributed around a historical estimate, or it can be any distribution supported on a bounded or unbounded interval. Speed and accuracy in the analysis are important. It may take longer timewise to calculate quality causal inferences. Statistical distributions, as mentioned previously include: uniform, Poisson, Gaussian, Binomial, or any distribution supported on a bounded or unbounded interval. Without loss of generality, a uniform distribution was selected in this example. Table 5 shows example randomized experimental units generated with their double blind randomized assignment without replacement. Duration is defined as the length of time that the experimental unit remained active in the e-commerce system where T1, T2, and T3 represented different time intervals. The randomized experimental units created a content specification protocol 214 (FIG. 2) that the e-commerce system will execute to quantify causal inferences. Content probability distribution was based on historical data and/or constraints initially (if any, otherwise uniform) and over time it is based on what is discovered through explore/exploit management. Product probability distribution was based on blocking and over time clustering as well.

TABLE 5
Example Experimental Units

| EU | Product | Duration | EV1 | IV 1 | IV2 | IV3 | IV4 |
|---|---|---|---|---|---|---|---|
| 1 | PR01 | T1 | Sales 1 | Level 1 | Level 2 | Level 2 | Level 2 |
| 2 | PR02 | T2 | Sales 2 | Level 1 | Level 2 | Level 2 | Level 1 |
| 3 | PR02 | T2 | Sales 2 | Level 2 | Level 2 | Level 1 | Level 1 |
| 4 | PR01 | T3 | Sales 1 | Level 1 | Level 2 | Level 1 | Level 1 |
| N | PR01 | T2 | Sales 1 | Level 1 | Level 1 | Level 1 | Level 1 |

Treatment assignment process 218 (FIG. 2) defined the baseline to be an average of all combinations of variables and assigned a fraction of the generated experimental units to baseline. The baseline monitoring process 222 (FIG. 2) assigned the baseline to explore and continued to refine the baseline definition (i.e., explore frequency) as method 300 continued to operate. Assessment occurred based on SOEU definition and initially one block and one cluster were assigned.

Method 300 continues with operation 306 with the processor 104 continually injecting the self-organized experimental units (SOEUs) into the e-commerce system 114 to generate quantified inferences about the content. The processor 104 injected the experimental units by following the instructions contained in the content specification protocol 214 (FIG. 2). Once injected into the e-commerce system, the SOEUs were initiated and executed. As experimental units concluded, then the next available unexecuted (i.e., assigned to a different block) experimental unit(s) began. POS data 228 was collected as a result of executing the SOEUs on the e-commerce system 114 and received by the core algorithmic processes 212 to calculate sales differences, confidence intervals, and casual interaction by the causal knowledge process 230 (FIG. 2).

Method 300 continues with operation 308 with processor 104 identifying one or more confidence intervals among the injected SOEUs. As experimental units concluded, confidence intervals were repeatedly calculated representing the inference(s) that experiment had on the sales of the two products. For each SOEU, the resulting sales for the two products were computed by processor 104. Table 6 represents how two of the SOEUs generated a response variable which expresses the resulting sales (RS1 or RS2) of either of the two products. Note: the calculation of response variable occurs for all SOEUs and was limited to only two to simplify this example.

TABLE 6
Response Variable Computation

| Product | EV1 | IV1 | IV2 | IV3 | IV4 | DV1 | DV2 | DV3 | DV4 |
|---|---|---|---|---|---|---|---|---|---|
| PR01 | Sales 1 | Level 1 | Level 2 | Level 2 | Level 2 | RS1 | RS1 | RS1 | RS1 |
| PR02 | Sales 2 | Level 1 | Level 2 | Level 2 | Level 1 | RS2 | RS2 | RS2 | RS2 |

The difference between response variables for the two products under different levels were computed. Note that only IV4, for this example, meets the requirement of one level difference. The difference (Δ) was calculated as |RS2−RS1|. Most commonly, differences are computed between adjacent levels (e.g. ‘ON’ vs ‘OFF’ or ‘Level 1’ vs ‘Level 2’) across “like” (i.e., exchangeable) experimental units They can also be computed as one level versus the average of all other levels (if more than one). A confidence interval (CI) was then computed about the mean and standard deviation of the sampling distribution (refer to Equation 1) where μ represents the mean and σ represents the standard deviation. The factor 1.96 provided for a 95% confidence interval.

$$CI = 1.96 \times \frac{( μ \pm Δ )}{σ} \qquad ( 1 )$$

This process is repeated for all SOEUs still operating under the assumption of normal distribution as a result of the Central Limit Theorem (normality was tested using the Shapiro-Wilk test), which produced one or more confidence intervals that represent the direction and magnitude of the causal effects due to the content elements.

Method 300 continues with operation 310 with processor 104 iteratively modifying the SOEUs based on the at least one confidence interval to identify at least one causal interaction of the content within the system. The explore/exploit management process (FIG. 2) identified variation among the computed confidence intervals to ascertain which levels had greater utility than others. The clustering of experimental units process 226 searched and identified variance within the confidence intervals relative to the external variables and identified effect modifiers. The continuous optimization process 232 (FIG. 2) further improved cluster assignment by performing statistical analyses (e.g., ANOVA) to expediently identify clusters. This was performed by aggregating differences between response variables across all levels and performing time series assessment. Once this clustering occurred, the calculated difference was specific to the cluster and no longer represented the effect among all SOEUs.

If no relationship is found between different SOEUs 112 and sales variance (or other parameter), the above operations can continue indefinitely. However, if there are underlying causal relationships, the processor 104 will identify causal interactions of the content within the e-commerce system 114. The benefit of optimizing the SOEU 112 durations is to regulate the time intervals to the durational effects of consumer response and buying patterns. If the SOEU 112 durations are too short, consumer effects from SOEUs 112 will carryover after the product is switched to the next SOEU 112, which would violate the independence casual inference requirement. This pollutes the attribution of sales variance to product content and dilutes the detection of effects. On the other hand, if the SOEU 112 durations are too long, the effects are clear but the system 100 is wasting statistical power by failing to maximize the number of SOEUs that the system 100 can execute overtime. Therefore, to optimize SOEUs 112, the processor 104 adaptively modifies the duration of at least one SOEU 112 until carryover effects of an SOEU 112 on a subsequent SOEU 112 are reduced. In some embodiments, the processor 104 can probability match on SOEU 112 duration so that the processor 104 may try longer/shorter durations to validate that the SOEU 112 duration is properly regulated. If the duration continues to be stable, clusters will become smaller provided there is continued opportunity to increase homogeneity within clusters and increase heterogeneity between clusters. At this point, for each IV, cluster, and level pair difference (time series), normality was tested and determined that the data inclusion window should be modified to ensure honest/unbiased confidence intervals representative of true causal interactions. The data inclusion window management process 224 (FIG. 2) manages normality testing and updates. The time duration (e.g., T1, T2, or T2) and content variable levels were updated by processor 104 changing the existing assumptions, resulting in a new SOEUs defined as operation 310 in method 300. As SOEUs lapse and are regenerated, new content specification protocols are produced by processor 104 and submitted to the e-commerce system 114. The causal knowledge process 230 (FIG. 2) repeated the analyses resulting in more accurate confidence intervals and identification of causal interaction within each cluster effectively determining the content options that had the greatest impact on the sales of the two products.

1. A system for optimizing business objectives of e-commerce content comprising:
memory; and
a processor coupled to the memory, the processor configured to:
receive one or more assumptions for randomized multivariate comparison of content, the content to be provided to users of a system;
repeatedly generate self-organizing experimental units (SOEUs) based on the one or more assumptions;
inject the SOEUs into the system to generate quantified inferences about the content;
identify, responsive to injecting the SOEUs, at least one confidence interval within the quantified inferences; and
iteratively modify the SOEUs based on the at least one confidence interval to identify at least one causal interaction of the e-commerce content within the system.

2. The system of claim 1, wherein baseline monitoring determines a number of previously injected SOEUs used to identify at least one confidence interval.

3. The system of claim 1, wherein the assumptions include constraints on the content.

4. The system of claim 3, wherein the constraints include at least one of a temporal constraint.

5. The system of claim 1, further comprising:
a user input device; and wherein the processor is further configured to:
receive user input that includes updated content; and
generate subsequent SOEUs based on the updated content.

6. The system of claim 1, wherein the assumptions include objective goals for the system.

7. The system of claim 6, wherein the objective goals include at least one of sales, profit margin, market share, or inventory management.

8. The system of claim 7, wherein the objective goals represent a weighted combination of both sales, profit margin, or inventory management.

9. The system of any of claim 1, wherein at least one SOEU includes a duration for which the respective SOEU is to be active in the system.

10. The system of claim 9, wherein the processor is further configured to:
generate a plurality of SOEUs with durations randomly selected based on a probability distribution.

11. The system of claim 1, wherein the processor is further configured to:
adaptively modify a duration of at least one SOEU until carryover effects of the SOEU on a subsequent SOEU are reduced.

12. The system of claim 1, wherein the processor is further configured to:
assign one or more treatment to the SOEUs;
identify separate causal interactions based on the one or more treatments; and
select optimal content for the one or more treatments based on the separate causal interactions.

13. The system of claim 12, wherein the one or more treatments are assigned based on blocking, clustering, or any combination thereof.

14. The system of claim 1, wherein the processor is further configured to:
assign at least one content option for one or more SOEUs based on exploiting variance in the computed confidence intervals.

15. The system of claim 14, wherein an aggressiveness of exploiting variance is determined through baseline monitoring.

16. The system of claim 1, further comprising:
a user display; and wherein the processor is further configured to:
provide, to the user display, a representation of at least one causal interaction of the content.

17. A computer-implemented method for optimizing business objectives of e-commerce content comprising:
receiving one or more assumptions for multivariate comparison of content, the content including content to be provided to users of a system;
repeatedly generating self-organizing experimental units (SOEUs) based on the one or more assumptions;
injecting the SOEUs into the system to generate quantified inferences about the content;
identifying, responsive to injecting the SOEUs, at least one confidence interval within the quantified inferences; and
iteratively modifying the SOEUs based on the at least one confidence interval to identify at least one causal interaction of the e-commerce content within the system.

18. The method of claim 17, wherein baseline monitoring determines a number of previously injected SOEUs used to identify at least one confidence interval.

19. The method of claim 17, wherein the assumptions include constraints on the content.

20. The method of claim 19, wherein the constraints include at least one of a temporal constraint.

21. The method of claim 1, further comprising:
receiving user input that includes updated content; and
generating subsequent SOEUs based on the updated content.

22. The method of claim 1, wherein the assumptions include objective goals for the system.

23. The method of claim 22, wherein the objective goals include at least one of sales, profit margin, market share, or inventory management.

24. The method of claim 23, wherein the objective goals represent a weighted combination of both sales, profit margin, or inventory management.

25. The method of claim 1, wherein at least one SOEU includes a duration for which the respective SOEU is to be active in the system.

26. The method of claim 25, further comprising:
generating a plurality of SOEUs with durations randomly selected based on a probability distribution.

27. The method of claim 1, further comprising:
adaptively modifying a data inclusion window of at least one SOEU until carryover effects of the SOEU on a subsequent SOEU are reduced.

28. The method of claim 1, further comprising:
assigning one or more treatments to the SOEUs;
identifying separate causal interactions based on the one or more treatments; and
selecting optimal content for the one or more treatments based on the separate causal interactions.

29. The method of claim 28, wherein the one or more treatments are assigned based on blocking, clustering, or any combination thereof.

30. The method of claim 1, further comprising:
assigning at least one content option for one or more SOEUs based on exploiting variance in the computed confidence intervals.

31. The method of claim 30, wherein an aggressiveness of exploiting variance is determined through baseline monitoring.

32. The method of claim 1, further comprising:
displaying a representation of at least one causal interaction of the content.
